(19) United States
(12) Patent Application Publication
(10) Pub. No.: US 2024/0023599 A1
(43) Pub. Date: Jan. 25, 2024

(54) AEROSOL-GENERATING ARTICLE WITH COATED SUSCEPTOR ELEMENT

(71) Applicant: PHILIP MORRIS PRODUCTS S.A., Neuchatel (CH)

(72) Inventors: Frederic Ulysse BUEHLER, Neuchatel (CH); Ricardo CALI, Mannheim (DE); Farhang MOHSENI, Neuchatel (CH); Toney Moses RAJAN, Mannheim (DE)

(73) Assignee: Philip Morris Products S.A., Neuchatel (CH)

(21) Appl. No.: 18/257,128

(22) PCT Filed: Dec. 13, 2021
(86) PCT No.: PCT/EP2021/085421

§ 371 Date: Jun. 13, 2023

(30) Foreign Application Priority Data
Dec. 21, 2020 (EP) 20216113.9

(51) Int. Cl. A24D 1/20; H05B 6/10; A24B 15/12; A24B 15/40; A24C 5/01

(52) U.S. Cl. CPC A24D 1/20; H05B 6/105; A24B 15/12; A24B 15/403; A24C 5/01; A24F 40/465

(57) ABSTRACT

An aerosol-generating article is provided for producing an inhalable aerosol upon heating, the aerosol-generating article including: an aerosol-generating element including aerosol-generating substrate including a homogenised tobacco material including aerosol former; and a susceptor arranged within the aerosol-generating element and configured to heat the homogenised tobacco material, the susceptor being coated with a coating composition including at least 20 percent by weight of an aerosol former, the coating composition further including about 0.5 percent by weight to about 10 percent by weight of isolated nicotine or a monoprotic nicotine salt derived from tobacco or both. A method of manufacturing the aerosol-generating article for generating an inhalable aerosol upon heating is also provided.

The present invention relates to an aerosol-generating article comprising an aerosol-generating substrate and adapted to produce an inhalable aerosol upon heating.

Aerosol-generating articles in which an aerosol-generating substrate, such as a tobacco-containing substrate, is heated rather than combusted, are known in the art. Typically, in such heated smoking articles an aerosol is generated by the transfer of heat from a heat source to a physically separate aerosol-generating substrate or material, which may be located in contact with, within, around, or downstream of the heat source. During use of the aerosol-generating article, volatile compounds are released from the aerosol-generating substrate by heat transfer from the heat source and are entrained in air drawn through the aerosol-generating article. As the released compounds cool, they condense to form an aerosol.

A number of prior art documents disclose aerosol-generating devices for consuming aerosol-generating articles. Such devices include, for example, electrically heated aerosol-generating devices in which an aerosol is generated by the transfer of heat from one or more electrical heater elements of the aerosol-generating device to the aerosol-generating substrate of a heated aerosol-generating article. For example, electrically heated aerosol-generating devices have been proposed that comprise an internal heater blade which is adapted to be inserted into the aerosol-generating substrate. As an alternative, inductively heatable aerosol-generating articles comprising an aerosol-generating substrate and a susceptor arranged within the aerosol-generating substrate have been proposed by WO 2015/176898.

Aerosol-generating articles in which a tobacco-containing substrate is heated rather than combusted present a number of challenges that were not encountered with conventional smoking articles. First of all, tobacco-containing substrates are typically heated to significantly lower temperatures compared with the temperatures reached by the combustion front in a conventional cigarette. This may have an impact on nicotine release from the tobacco-containing substrate and nicotine delivery to the consumer. At the same time, if the heating temperature is increased in an attempt to boost nicotine delivery, then the aerosol generated typically needs to be cooled to a greater extent and more rapidly before it reaches the consumer.

Secondly, heating a tobacco-containing aerosol-generating substrate even to one such temperature required for aerosol formation typically takes some time, and so there may be a delay in aerosol delivery to the consumer. This phenomenon, whereby when the user initially draws upon the article, the aerosol reaching the user may be relatively low in flavour or nicotine content or both, is often referred to as “cold puff” effect or “empty puff” effect.

One such delay may for example be detected in aerosol-generating rods and articles wherein the aerosol-generating substrate comprises a homogenised tobacco material, since the aerosol former and nicotine may not be especially readily available for release. In particular, this may occur where a cast leaf homogenised tobacco material is used that has been prepared from a slurry containing the aerosol former, as opposed to one wherein the aerosol former has been applied (for example, sprayed) onto the formed sheet.

It has been previously proposed to address this by providing two or more independent heating zones in the device by which the aerosol-generating rod or article is heated. As this enables different heating profiles to be implemented for different portions of the aerosol-generating substrate, this may help counter the “cold puff” effect.

It would, however, be desirable to provide a new and improved aerosol-generating rod or article adapted to address the initial “cold puff” or “empty puff” effect. For example, it would be desirable to provide a novel and improved aerosol-generating rod or article capable of more promptly providing a satisfactory aerosol delivery to the user and enables a finer tuning of the aerosol delivery during use, as a whole.

It would be especially desirable to provide one such novel and improved aerosol-generating rod or article that can generate a satisfactory aerosol delivery to the user at lower temperatures while still heating the tobacco-containing substrate for regular consumption.

In general, it would be desirable to provide an aerosol-generating article that is adapted to address the initial “cold puff” or “empty puff” effect and that is easy to use and may have improved practicality.

It would be desirable to provide one such aerosol-generating rod or article that can be manufactured efficiently and at high speed without the need for extensive modification of existing equipment.

Therefore, it would be desirable to provide a new and improved aerosol-generating article adapted to achieve at least one of the desirable results described above.

The present disclosure relates to an aerosol-generating article for producing an inhalable aerosol upon heating. The aerosol-generating article may comprise an aerosol-generating element comprising aerosol-generating substrate. The aerosol-generating substrate may comprise a homogenised tobacco material comprising aerosol former. The aerosol-generating article may further comprise a susceptor arranged within the aerosol-generating element and configured to heat the homogenised tobacco material. The susceptor may be coated with a coating composition. The coating composition may comprise at least 20 percent by weight of an aerosol former. The coating composition may further comprise isolated nicotine or a monoprotic nicotine salt or both.

According to the present invention, there is provided an aerosol-generating article for producing an inhalable aerosol upon heating, the aerosol-generating article comprising: an aerosol-generating element comprising aerosol-generating substrate, wherein the aerosol-generating substrate comprises a homogenised tobacco material comprising aerosol former; and a susceptor arranged within the aerosol-generating element and configured to heat the homogenised tobacco material, the susceptor being coated with a coating composition comprising at least 20 percent by weight of an aerosol former, the coating composition further comprising isolated nicotine or a monoprotic nicotine salt or both.

In contrast to existing aerosol-generating articles, aerosol-generating articles in accordance with the present invention include a susceptor coated with a coating composition comprising a predetermined amount of aerosol former and isolated nicotine or a nicotine salt or both.

The inventors have found that by thermally coupling a susceptor coated with one such composition with a homogenised tobacco based aerosol-generating substrate it is advantageously possible to at least partly obviate the initial delay in aerosol generation and delivery often found with existing aerosol-generating articles.

Without wishing to be bound by theory it is understood that the nicotine—be it present in isolated form or as a salt of a monoprotic acid or both—and the aerosol former in the coating composition are more readily available than the nicotine and aerosol former contained within homogenised tobacco material. Besides, in an initial heating cycle the heat generated by induction via the susceptor is understood to be transferred quickly and directly to the coating composition, and therefore a first burst-like release of nicotine-containing aerosol can be provided to the consumer while the temperature of the bulk of the substrate containing homogenised tobacco material that surrounds the coated susceptor continues to be raised. Thus, when aerosol coming from the homogenised tobacco material begins to be released at a satisfactory rate and with desirable flavour and nicotine content, this flow provides a sustained release of aerosol for the remainder of the use cycle.

By adjusting the content of aerosol former and nicotine in the composition, as well as the ratio between the content of aerosol former and nicotine in the composition and the corresponding contents in the homogenised tobacco material, it is advantageously possible to fine tune the transition from one aerosol source to the other. In particular, this may be done such that the transition is particularly smooth and undetectable for the consumer.

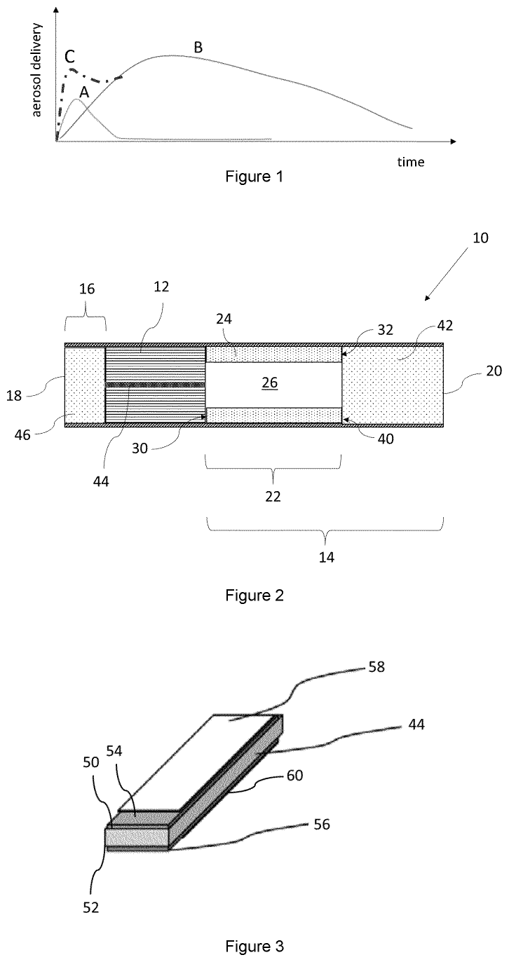

FIG. 1 shows qualitatively how aerosol delivery from each one of a homogenised tobacco substrate and a coating composition provided on the susceptor evolves over time. As illustrated in FIG. 1 by line A, aerosol is released quickly from the coating composition upon starting to heat the article, and rapidly reaches a maximum before decreasing almost as rapidly. The content of aerosol species in the coating composition is depleted relatively quickly, and so release of aerosol from the coating composition substantially stops after a relatively short time. On the other hand, release of aerosol from the homogenised tobacco substrate, represented by line B, is initially less significant, and it is only after release of aerosol from the coating composition begins to decrease that the amount of aerosol released from the homogenised tobacco substrate reaches a comparable level. By the time release of aerosol from the coating composition has all but stopped, release of aerosol from the homogenised tobacco substrate has more than doubled in intensity, and will only decrease smoothly over a longer period of time covering the remainder of the cycle of use of the article.

At any time, during use, the consumer receives in effect the sum of a flow of aerosol species released from the coating composition provided on the susceptor and a flow of aerosol species released from the homogenised tobacco substrate. Dotted line C in FIG. 1 illustrates this effect during the initial portion of the cycle of use of the article. As can be seen in the graph, release of aerosol from the coating composition provided on the susceptor compensates for the initial delay in the release of aerosol from the homogenised tobacco substrate until the latter substantially takes over. This is perceived by the consumer as an overall more prompt, homogenous and consistent aerosol delivery throughout a cycle of use of the article compared with existing aerosol-generating articles.

In the following, methods will also be described that allow for aerosol-generating articles providing one or more of the benefits discussed above to be manufactured on existing production lines without requiring a major reconfiguration thereof.

As described briefly above, the present invention provides an aerosol-generating article for generating an inhalable aerosol upon heating. The aerosol-generating article comprises an aerosol-generating element comprising aerosol-generating substrate.

The term “aerosol generating article” is used herein to denote an article wherein an aerosol generating substrate is heated to produce an deliver inhalable aerosol to a consumer. As used herein, the term “aerosol generating substrate” denotes a substrate capable of releasing volatile compounds upon heating to generate an aerosol.

A conventional cigarette is lit when a user applies a flame to one end of the cigarette and draws air through the other end. The localised heat provided by the flame and the oxygen in the air drawn through the cigarette causes the end of the cigarette to ignite, and the resulting combustion generates an inhalable smoke. By contrast, in heated aerosol generating articles, an aerosol is generated by heating a flavour generating substrate, such as tobacco. Known heated aerosol generating articles include, for example, electrically heated aerosol generating articles and aerosol generating articles in which an aerosol is generated by the transfer of heat from a combustible fuel element or heat source to a physically separate aerosol forming material. For example, aerosol generating articles according to the invention find particular application in aerosol generating systems comprising an electrically heated aerosol generating device having an internal heater blade which is adapted to be inserted into the rod of aerosol generating substrate. Aerosol generating articles of this type are described in the prior art, for example, in EP 0822670.

As used herein, the term “aerosol generating device” refers to a device comprising a heater element that interacts with the aerosol generating substrate of the aerosol generating article to generate an aerosol.

The aerosol-generating element may be in the form of a rod. As used herein with reference to the present invention, the term “rod” is used to denote a generally cylindrical element of substantially circular, oval or elliptical cross-section.

As used herein, the term “longitudinal” refers to the direction corresponding to the main longitudinal axis of the aerosol-generating article, which extends between the upstream and downstream ends of the aerosol-generating article. As used herein, the terms “upstream” and “downstream” describe the relative positions of elements, or portions of elements, of the aerosol-generating article in relation to the direction in which the aerosol is transported through the aerosol-generating article during use.

During use, air is drawn through the aerosol-generating article in the longitudinal direction. The term “transverse” refers to the direction that is perpendicular to the longitudinal axis. Any reference to the “cross-section” of the aerosol-generating article or a component of the aerosol-generating article refers to the transverse cross-section unless stated otherwise.

The term “length” denotes the dimension of a component of the aerosol-generating article in the longitudinal direction. For example, it may be used to denote the dimension of the rod or of the elongate tubular elements in the longitudinal direction.

The aerosol-generating substrate is a solid aerosol-generating substrate. In more detail, the aerosol-generating substrate comprises homogenised tobacco material.

Homogenised tobacco material is an example of “homogenised plant material”. As used herein, the term “homogenised plant material” encompasses any plant material formed by the agglomeration of particles of plant. For example, sheets or webs of homogenised tobacco material for the aerosol-generating substrates of the present invention may be formed by agglomerating particles of tobacco material obtained by pulverising, grinding or comminuting one or more of tobacco leaf lamina and tobacco leaf stems. A homogenised plant material may be produced by casting, extrusion, paper making processes or other any other suitable processes known in the art.

The homogenised tobacco material can be provided in any suitable form. For example, the homogenised tobacco material may be in the form of one or more sheets. As used herein with reference to the invention, the term “sheet” describes a laminar element having a width and length substantially greater than the thickness thereof. The homogenised tobacco material may be in the form of a plurality of pellets or granules.

The homogenised tobacco material may be in the form of a plurality of strands, strips or shreds. As used herein, the term “strand” describes an elongate element of material having a length that is substantially greater than the width and thickness thereof. The term “strand” should be considered to encompass strips, shreds and any other homogenised tobacco material having a similar form. The strands of homogenised tobacco material may be formed from a sheet of homogenised tobacco material, for example by cutting or shredding, or by other methods, for example, by an extrusion method.

In some embodiments, the strands may be formed in situ within the aerosol-generating substrate as a result of the splitting or cracking of a sheet of homogenised tobacco material during formation of the aerosol-generating substrate, for example, as a result of crimping. The strands of homogenised tobacco material within the aerosol-generating substrate may be separate from each other. Alternatively, each strand of homogenised tobacco material within the aerosol-generating substrate may be at least partially connected to an adjacent strand or strands along the length of the strands. For example, adjacent strands may be connected by one or more fibres. This may occur, for example, where the strands have been formed due to the splitting of a sheet of homogenised tobacco material during production of the aerosol-generating substrate, as described above.

Preferably, the aerosol-generating substrate is in the form of one or more sheets of homogenised tobacco material. In various embodiments of the invention, the one or more sheets of homogenised tobacco material may be produced by a casting process. In various embodiments of the invention, the one or more sheets of homogenised tobacco material may be produced by a paper-making process. The one or more sheets as described herein may each individually have a thickness of between 100 micrometres and 600 micrometres, preferably between 150 micrometres and 300 micrometres, and most preferably between 200 micrometres and 250 micrometres. Individual thickness refers to the thickness of the individual sheet, whereas combined thickness refers to the total thickness of all sheets that make up the aerosol-generating substrate. For example, if the aerosol-generating substrate is formed from two individual sheets, then the combined thickness is the sum of the thickness of the two individual sheets or the measured thickness of the two sheets where the two sheets are stacked in the aerosol-generating substrate.

The one or more sheets as described herein may each individually have a grammage of between about 100 g/m² and about 300 g/m².

The one or more sheets as described herein may each individually have a density of from about 0.3 g/cm³ to about 1.3 g/cm³, and preferably from about 0.7 g/cm³ to about 1.0 g/cm³.

In embodiments of the present invention in which the aerosol-generating substrate comprises one or more sheets of homogenised tobacco material, the sheets are preferably in the form of one or more gathered sheets. As used herein, the term “gathered” denotes that the sheet of homogenised tobacco material is convoluted, folded, or otherwise compressed or constricted substantially transversely to the cylindrical axis of a plug or a rod.

The one or more sheets of homogenised tobacco material may be gathered transversely relative to the longitudinal axis thereof and circumscribed with a wrapper to form a continuous rod or a plug.

The one or more sheets of homogenised tobacco material may advantageously be crimped or similarly treated. As used herein, the term “crimped” denotes a sheet having a plurality of substantially parallel ridges or corrugations. Alternatively or in addition to being crimped, the one or more sheets of homogenised tobacco material may be embossed, debossed, perforated or otherwise deformed to provide texture on one or both sides of the sheet.

Preferably, each sheet of homogenised tobacco material may be crimped such that it has a plurality of ridges or corrugations substantially parallel to the cylindrical axis of the plug. This treatment advantageously facilitates gathering of the crimped sheet of homogenised tobacco material to form the plug. Preferably, the one or more sheets of homogenised tobacco material may be gathered. It will be appreciated that crimped sheets of homogenised tobacco material may alternatively or in addition have a plurality of substantially parallel ridges or corrugations disposed at an acute or obtuse angle to the cylindrical axis of the plug. The sheet may be crimped to such an extent that the integrity of the sheet becomes disrupted at the plurality of parallel ridges or corrugations causing separation of the material, and results in the formation of shreds, strands or strips of homogenised tobacco material.

Alternatively, the one or more sheets of homogenised tobacco material may be cut into strands as referred to above. In such embodiments, the aerosol-generating substrate comprises a plurality of strands of the homogenised tobacco material. The strands may be used to form a plug. Typically, the width of such strands is about 5 millimetres, or about 4 millimetres, or about 3 millimetres, or about 2 millimetres or less. The length of the strands may be greater than about millimetres, between about 5 millimetres to about 15 millimetres, about 8 millimetres to about 12 millimetres, or about 12 millimetres. Preferably, the strands have substantially the same length as each other. The length of the strands may be determined by the manufacturing process whereby a rod is cut into shorter plugs and the length of the strands corresponds to the length of the plug. The strands may be fragile which may result in breakage especially during transit. In such cases, the length of some of the strands may be less than the length of the plug.

The plurality of strands preferably extend substantially longitudinally along the length of the aerosol-generating substrate, aligned with the longitudinal axis. Preferably, the plurality of strands are therefore aligned substantially parallel to each other.

The homogenised tobacco material may comprise up to about 95 percent by weight of plant particles, on a dry weight basis. Preferably, the homogenised tobacco material comprises up to about 90 percent by weight of plant particles, more preferably up to about 80 percent by weight of plant particles, more preferably up to about 70 percent by weight of plant particles, more preferably up to about 60 percent by weight of plant particles, more preferably up to about 50 percent by weight of plant particles, on a dry weight basis.

For example, the homogenised tobacco material may comprise between about 2.5 percent and about 95 percent by weight of plant particles, or about 5 percent and about 90 percent by weight of plant particles, or between about 10 percent and about 80 percent by weight of plant particles, or between about 15 percent and about 70 percent by weight of plant particles, or between about 20 percent and about 60 percent by weight of plant particles, or between about percent and about 50 percent by weight of plant particles, on a dry weight basis.

Sheets of homogenised tobacco material for use in the present invention may have a tobacco content of at least about 40 percent by weight on a dry weight basis, more preferably of at least about 50 percent by weight on a dry weight basis more preferably at least about 70 percent by weight on a dry weight basis and most preferably at least about 90 percent by weight on a dry weight basis.

With reference to the present invention, the term “tobacco particles” describes particles of any plant member of the genus Nicotiana. The term “tobacco particles” encompasses ground or powdered tobacco leaf lamina, ground or powdered tobacco leaf stems, tobacco dust, tobacco fines, and other particulate tobacco by-products formed during the treating, handling and shipping of tobacco. In a preferred embodiment, the tobacco particles are substantially all derived from tobacco leaf lamina. By contrast, isolated nicotine and nicotine salts are compounds derived from tobacco but are not considered tobacco particles for purposes of the invention and are not included in the percentage of particulate plant material.

The tobacco particles may be prepared from one or more varieties of tobacco plants. Any type of tobacco may be used in a blend. Examples of tobacco types that may be used include, but are not limited to, sun-cured tobacco, flue-cured tobacco, Burley tobacco, Maryland tobacco, Oriental tobacco, Virginia tobacco, and other speciality tobaccos.

Flue-curing is a method of curing tobacco, which is particularly used with Virginia tobaccos. During the flue-curing process, heated air is circulated through densely packed tobacco. During a first stage, the tobacco leaves turn yellow and wilt. During a second stage, the laminae of the leaves are completely dried. During a third stage, the leaf stems are completely dried.

Burley tobacco plays a significant role in many tobacco blends. Burley tobacco has a distinctive flavour and aroma and also has an ability to absorb large amounts of casing.

Oriental is a type of tobacco which has small leaves, and high aromatic qualities. However, Oriental tobacco has a milder flavour than, for example, Burley. Generally, therefore, Oriental tobacco is used in relatively small proportions in tobacco blends.

Kasturi, Madura and Jatim are subtypes of sun-cured tobacco that can be used. Preferably, Kasturi tobacco and flue-cured tobacco may be used in a blend to produce the tobacco particles. Accordingly, the tobacco particles in the particulate plant material may comprise a blend of Kasturi tobacco and flue-cured tobacco.

The tobacco particles may have a nicotine content of at least about 2.5 percent by weight, based on dry weight. More preferably, the tobacco particles may have a nicotine content of at least about 3 percent, even more preferably at least about 3.2 percent, even more preferably at least about 3.5 percent, most preferably at least about 4 percent by weight, based on dry weight.

In certain other embodiments of the invention, the homogenised tobacco material may comprise tobacco particles in combination with non-tobacco plant flavour particles. Preferably, the non-tobacco plant flavour particles are selected from one or more of: ginger particles, eucalyptus particles, clove particles and star anise particles. Preferably, in such embodiments, the homogenised tobacco material comprises at least about 2.5 percent by weight of the non-tobacco plant flavour particles, on a dry weight basis, with the remainder of the plant particles being tobacco particles. Preferably, the homogenised tobacco material comprises at least about 4 percent by weight of non-tobacco plant flavour particles, more preferably at least about 6 percent by weight of non-tobacco plant flavour particles, more preferably at least about 8 percent by weight of non-tobacco plant flavour particles and more preferably at least about 10 percent by weight of non-tobacco plant flavour particles, on a dry weight basis. Preferably, the homogenised tobacco material comprises up to about 20 percent by weight of non-tobacco plant flavour particles, more preferably up to about 18 percent by weight of non-tobacco plant flavour particles, more preferably up to about 16 percent by weight of non-tobacco plant flavour particles.

The weight ratio of the non-tobacco plant flavour particles and the tobacco particles in the particulate plant material forming the homogenised tobacco material may vary depending on the desired flavour characteristics and composition of the aerosol produced from the aerosol-generating substrate during use. Preferably, the homogenised tobacco material comprises at least a 1:30 weight ratio of non-tobacco plant flavour particles to tobacco particles, more preferably at least a 1:20 weight ratio of non-tobacco plant flavour particles to tobacco particles, more preferably at least a 1:10 weight ratio of non-tobacco plant flavour particles to tobacco particles and most preferably at least a 1:5 weight ratio of non-tobacco plant flavour particles to tobacco particles, on a dry weight basis.

The homogenised tobacco material preferably comprises no more than 95 percent by weight of the particulate plant material, on a dry weight basis. The particulate plant material is therefore typically combined with one or more other components to form the homogenised tobacco material.

The homogenised tobacco material may further comprise a binder to alter the mechanical properties of the particulate plant material, wherein the binder is included in the homogenised tobacco material during manufacturing as described herein. Suitable exogenous binders would be known to the skilled person and include but are not limited to: gums such as, for example, guar gum, xanthan gum, arabic gum and locust bean gum; cellulosic binders such as, for example, hydroxypropyl cellulose, carboxymethyl cellulose, hydroxyethyl cellulose, methyl cellulose and ethyl cellulose; polysaccharides such as, for example, starches, organic acids, such as alginic acid, conjugate base salts of organic acids, such as sodium-alginate, agar and pectins; and combinations thereof. Preferably, the binder comprises guar gum.

The binder may be present in an amount of from about 1 percent to about 10 percent by weight, based on the dry weight of the homogenised tobacco material, preferably in an amount of from about 2 percent to about 5 percent by weight, based on the dry weight of the homogenised tobacco material.

Alternatively or in addition, the homogenised tobacco material may further comprise one or more lipids to facilitate the diffusivity of volatile components (for example, aerosol formers, gingerols and nicotine), wherein the lipid is included in the homogenised tobacco material during manufacturing as described herein. Suitable lipids for inclusion in the homogenised tobacco material include, but are not limited to: medium-chain triglycerides, cocoa butter, palm oil, palm kernel oil, mango oil, shea butter, soybean oil, cottonseed oil, coconut oil, hydrogenated coconut oil, candellila wax, carnauba wax, shellac, sunflower wax, sunflower oil, rice bran, and Revel A; and combinations thereof.

Alternatively or in addition, the homogenised tobacco material may further comprise a pH modifier.

Alternatively or in addition, the homogenised tobacco material may further comprise fibres to alter the mechanical properties of the homogenised tobacco material, wherein the fibres are included in the homogenised tobacco material during manufacturing as described herein. Suitable exogenous fibres for inclusion in the homogenised tobacco material are known in the art and include fibres formed from non-tobacco material and non-ginger material, including but not limited to: cellulose fibres; soft-wood fibres; hard-wood fibres; jute fibres and combinations thereof. Exogenous fibres derived from tobacco and/or ginger can also be added. Any fibres added to the homogenised tobacco material are not considered to form part of the “particulate plant material” as defined above. Prior to inclusion in the homogenised tobacco material, fibres may be treated by suitable processes known in the art including, but not limited to: mechanical pulping; refining; chemical pulping; bleaching; sulfate pulping; and combinations thereof. A fibre typically has a length greater than its width.

Suitable fibres typically have lengths of greater than 400 micrometres and less than or equal to 4 millimetres, preferably within the range of 0.7 millimetres to 4 millimetres. Preferably, the fibres are present in an amount of about 2 percent to about 15 percent by weight, most preferably at about 4 percent by weight, based on the dry weight of the substrate.

In the context of the present invention, the homogenised tobacco material further comprises one or more aerosol formers. Upon volatilisation, an aerosol former can convey other vaporised compounds released from the aerosol-generating substrate upon heating, such as nicotine and flavourants, in an aerosol. Suitable aerosol formers for inclusion in the homogenised tobacco material are known in the art and include, but are not limited to: polyhydric alcohols, such as triethylene glycol, propylene glycol, 1,3-butanediol and glycerol; esters of polyhydric alcohols, such as glycerol mono-, di- or triacetate; and aliphatic esters of mono-, di- or polycarboxylic acids, such as dimethyl dodecanedioate and dimethyl tetradecanedioate.

The homogenised tobacco material may have an aerosol former content of between about percent and about 30 percent by weight on a dry weight basis. Preferably, the homogenised tobacco material has an aerosol former content of at least about 10 percent by weight on a dry weight basis, more preferably at least about 15 percent by weight on a dry weight basis.

The homogenised tobacco material has preferably an aerosol former content of less than or equal to about 25 percent by weight on a dry weight basis, more preferably less than or equal to about 20 percent by weight on a dry weight basis.

In some embodiments, the homogenised tobacco material has an aerosol former content from 5 percent to 25 percent by weight on a dry weight basis, preferably from 10 percent to 25 percent by weight on a dry weight basis, more preferably from 15 percent to 25 percent by weight on a dry weight basis. In other embodiments, the homogenised tobacco material has an aerosol former content from 5 percent to 20 percent by weight on a dry weight basis, preferably from 10 percent to 20 percent by weight on a dry weight basis, more preferably from 15 percent to 20 percent by weight on a dry weight basis.

In other embodiments, the homogenised tobacco material may have an aerosol former content of about 30 percent by weight to about 45 percent by weight. This relatively high level of aerosol former is particularly suitable for aerosol-generating substrates that are intended to be heated at a temperature of less than 275 degrees Celsius. In such embodiments, the homogenised tobacco material preferably further comprises between about 2 percent by weight and about 10 percent by weight of cellulose ether, on a dry weight basis and between about 5 percent by weight and about 50 percent by weight of additional cellulose, on a dry weight basis. The use of the combination of cellulose ether and additional cellulose has been found to provide a particularly effective delivery of aerosol when used in an aerosol-generating substrate having an aerosol former content of between 30 percent by weight and 45 percent by weight.

Suitable cellulose ethers include but are not limited to methyl cellulose, hydroxypropyl methyl cellulose, ethyl cellulose, hydroxyl ethyl cellulose, hydroxyl propyl cellulose, ethyl hydroxyl ethyl cellulose and carboxymethyl cellulose (CMC). In particularly preferred embodiments, the cellulose ether is carboxymethyl cellulose.

As used herein, the term “additional cellulose” encompasses any cellulosic material incorporated into the homogenised tobacco material which does not derive from the non-tobacco plant particles or tobacco particles provided in the homogenised tobacco material. The additional cellulose is therefore incorporated in the homogenised tobacco material in addition to the non-tobacco plant material or tobacco material, as a separate and distinct source of cellulose to any cellulose intrinsically provided within the non-tobacco plant particles or tobacco particles. The additional cellulose will typically derive from a different plant to the non-tobacco plant particles or tobacco particles. Preferably, the additional cellulose is in the form of an inert cellulosic material, which is sensorially inert and therefore does not substantially impact the organoleptic characteristics of the aerosol generated from the aerosol-generating substrate. For example, the additional cellulose is preferably a tasteless and odourless material.

The additional cellulose may comprise cellulose powder, cellulose fibres, or a combination thereof.

The aerosol former may act as a humectant in the aerosol-generating substrate.

The aerosol-generating element comprising the aerosol-generating substrate may be circumscribed by a wrapper, which may be a paper wrapper or a non-paper wrapper. Suitable paper wrappers for use in specific embodiments of the invention are known in the art and include, but are not limited to: cigarette papers; and filter plug wraps. Suitable non-paper wrappers for use in specific embodiments of the invention are known in the art and include, but are not limited to sheets of homogenised tobacco materials. In certain preferred embodiments, the wrapper may be formed of a laminate material comprising a plurality of layers. Preferably, the wrapper is formed of an aluminium co-laminated sheet. The use of a co-laminated sheet comprising aluminium advantageously prevents combustion of the aerosol-generating substrate in the event that the aerosol-generating substrate should be ignited, rather than heated in the intended manner.

As described briefly above, in an aerosol-generating article in accordance with the present invention, a susceptor is arranged within the aerosol-generating element and configured to heat the aerosol-generating substrate, for example the homogenised tobacco material. Further, the susceptor is coated with a coating composition, which will be described in greater detail below.

As used herein with reference to the present invention, the term “susceptor” refers to a material that can convert electromagnetic energy into heat. When located within a fluctuating electromagnetic field, eddy currents induced in the susceptor cause heating of the susceptor. As the elongate susceptor is thermally coupled, for example located in thermal contact, with the aerosol-generating substrate, the aerosol-generating substrate is heated by the susceptor.

Preferably, the coated susceptor is surrounded by the aerosol-generating substrate. In preferred embodiments, the coated susceptor is surrounded by homogenised tobacco material, in particularly preferred embodiments by homogenised tobacco material.

More preferably, the susceptor is an elongate susceptor. When used for describing the susceptor, the term “elongate” means that the susceptor has a length dimension that is greater than its width dimension or its thickness dimension, for example greater than twice its width dimension or its thickness dimension.

The susceptor is preferably arranged substantially longitudinally within the aerosol-generating element. This means that the length dimension of the elongate susceptor is arranged to be approximately parallel to the longitudinal direction of the aerosol-generating element, for example within plus or minus 10 degrees of parallel to the longitudinal direction of the aerosol-generating element. In preferred embodiments, the elongate susceptor may be positioned in a radially central position within the aerosol-generating element, and extends along the longitudinal axis of the aerosol-generating element, particularly where the aerosol-generating element is provided in the form of a rod.

By way of example, a coated, elongate susceptor may be arranged substantially longitudinally within a rod of aerosol-generating substrate comprising homogenised tobacco material so that the susceptor is thermally coupled with the aerosol-generating substrate.

Preferably, the susceptor extends all the way to a downstream end of the aerosol-generating element. In some embodiments, the susceptor may extend all the way to an upstream end of the aerosol-generating element. In particularly preferred embodiments, the susceptor has substantially the same length as the aerosol-generating element, and extends from the upstream end of the rod to the downstream end of the aerosol-generating element.

The susceptor is preferably in the form of a pin, rod, strip or blade.

The susceptor preferably has a length from about 5 millimetres to about 15 millimetres, for example from about 6 millimetres to about 12 millimetres, or from about 8 millimetres to about millimetres.

A ratio between the length of the susceptor and the overall length of the aerosol-generating article may be from about 0.2 to about 0.35.

Preferably, a ratio between the length of the susceptor and the overall length of the aerosol-generating article is at least about 0.22, more preferably at least about 0.24, even more preferably at least about 0.26. A ratio between the length of the susceptor and the overall length of the aerosol-generating article is preferably less than about 0.34, more preferably less than about 0.32, even more preferably less than about 0.3.

In some embodiments, a ratio between the length of the susceptor and the overall length of the aerosol-generating article is preferably from about 0.22 to about 0.34, more preferably from about 0.24 to about 0.34, even more preferably from about 0.26 to about 0.34. In other embodiments, a ratio between the length of the susceptor and the overall length of the aerosol-generating article is preferably from about 0.22 to about 0.32, more preferably from about 0.24 to about 0.32, even more preferably from about 0.26 to about 0.32. In further embodiments, a ratio between the length of the susceptor and the overall length of the aerosol-generating article is preferably from about 0.22 to about 0.3, more preferably from about 0.24 to about 0.3, even more preferably from about 0.26 to about 0.3.

In a particularly preferred embodiment, a ratio between the length of the susceptor and the overall length of the aerosol-generating article is about 0.27.

The susceptor preferably has a width from about 1 millimetres to about 6 millimetres. More preferably, the susceptor has a width of at least about 2 millimetres. Even more preferably, the susceptor has a width of at least about 3 millimetres. In particularly preferred embodiments, the susceptor has a width of about 4 millimetres or 5 millimetres. This is thought to maximise the surface area available for heat transfer, whilst ensuring that the susceptor is entirely surrounded by aerosol-generating substrate.

The susceptor may generally have a thickness from about 0.01 millimetres to about 2 millimetres, for example from about 0.5 millimetres to about 2 millimetres. In some embodiments, the susceptor preferably has a thickness from about 10 micrometres to about 500 micrometres, more preferably from about 10 micrometres to about 100 micrometres.

If the susceptor has a constant cross-section, for example a circular cross-section, it has a preferable width or diameter from about 1 millimetre to about 5 millimetres.

If the susceptor has the form of a strip or blade, the strip or blade preferably has a rectangular shape having a width of preferably from about 2 millimetres to about 8 millimetres, more preferably from about 3 millimetres to about 5 millimetres. By way of example, a susceptor in the form of a strip of blade may have a width of about 4 millimetres.

If the susceptor has the form of a strip or blade, the strip or blade preferably has a rectangular shape and a thickness from about 0.03 millimetres to about 0.15 millimetres, more preferably from about 0.05 millimetres to about 0.09 millimetres. By way of example, a susceptor in the form of a strip of blade may have a thickness of about 0.07 millimetres.

In a preferred embodiment, the elongate susceptor (is in the form of a strip or blade, preferably has a rectangular shape, and) has a thickness from about 55 micrometres to about 65 micrometres.

More preferably, the elongate susceptor has a thickness from about 57 micrometres to about 63 micrometres. Even more preferably, the elongate susceptor has a thickness from about 58 micrometres to about 62 micrometres. In a particularly preferred embodiment, the elongate susceptor has a thickness of about 60 micrometres.

Without wishing to be bound by theory, the inventors consider that, as a whole, the selection of a given thickness for the susceptor is also impacted by constraints set by the selected length and width of the susceptor, as well as by constraints set by the geometry and dimensions of the rod of aerosol-generating substrate. By way of example, the length of the susceptor is preferably selected such as to match the length of the aerosol-generating element. The width of the susceptor should preferably be chosen such that displacement of the susceptor within the substrate is prevented, whilst also enabling easy insertion during manufacturing.

The inventors have found that in an aerosol-generating article wherein a susceptor having a thickness within the range described above is provided for supplying heat inductively during use, it is advantageously possibly to generate and distribute heat throughout the aerosol-generating substrate in an especially effective and efficient way. Without wishing to be bound by theory, the inventors believe that this is because one such susceptor is adapted to provide optimal heat generation and heat transfer, by virtue of susceptor surface area and inductive power. By contrast, a thinner susceptor may be too easy to deform and may not maintain the desired shape and orientation within the rod of aerosol-generating substrate during manufacture of the aerosol-generating article, which may result in a less homogenous and less finely tuned heat distribution during use. At the same time, a thicker susceptor may be more difficult to cut to length with precision and consistency, and this may also impact how precisely the susceptor can be provided in longitudinal alignment within the rod of aerosol-generating substrate, thus also potentially impacting the homogeneity of heat distribution within the rod. These advantageous effects are felt especially when the susceptor extends all the way to the downstream end of the rod of aerosol-generating article. This is thought to be because the resistance to draw (RTD) downstream of the susceptor can thus basically be minimised, as there is no aerosol-generating substrate within the rod at a location downstream of the susceptor that can contribute to the RTD.

Without wishing to be bound by theory, the inventors consider that the most downstream portion of the aerosol-generating element may act, to an extent, as a filter with respect to more upstream portions of the aerosol-generating element. Thus, the inventors believe it is desirable to be able to heat homogeneously also the most downstream portion of the aerosol-generating element, such that this is actively involved in the release of volatile aerosol species and contributes to the overall aerosol generation and delivery, and any possible filtration effect—which may hinder the delivery of aerosol to the consumer—is positively countered by the release of volatile aerosol species throughout the whole of the aerosol-generating element.

The susceptor may be formed from any material that can be inductively heated to a temperature sufficient to generate an aerosol from the aerosol-generating substrate. Preferred susceptors comprise a metal or carbon.

A preferred susceptor may comprise or consist of a ferromagnetic material, for example a ferromagnetic alloy, ferritic iron, or a ferromagnetic steel or stainless steel. A suitable susceptor may be, or comprise, aluminium. Preferred susceptors may be formed from 400 series stainless steels, for example grade 410, or grade 420, or grade 430 stainless steel. Different materials will dissipate different amounts of energy when positioned within electromagnetic fields having similar values of frequency and field strength.

Thus, parameters of the susceptor such as material type, length, width, and thickness may all be altered to provide a desired power dissipation within a known electromagnetic field. Preferred susceptors may be heated to a temperature in excess of 250 degrees Celsius.

Suitable susceptors may comprise a non-metallic core with a metal layer disposed on the non-metallic core, for example metallic tracks formed on a surface of a ceramic core. A susceptor may have a protective external layer, for example a protective ceramic layer or protective glass layer encapsulating the susceptor. The susceptor may comprise a protective layer formed of a glass, a ceramic, or an inert metal, and extending over the core of susceptor material.

The susceptor is arranged so as to be thermally coupled with the aerosol-generating substrate. Thus, when the susceptor heats up the aerosol-generating substrate is heated up and an aerosol is formed.

The susceptor may be a multi-material susceptor and may comprise a first susceptor material and a second susceptor material. The first susceptor material is disposed in intimate physical contact with the second susceptor material. The second susceptor material preferably has a Curie temperature that is lower than 500 degrees Celsius. The first susceptor material is preferably used primarily to heat the susceptor when the susceptor is placed in a fluctuating electromagnetic field. Any suitable material may be used. For example the first susceptor material may be aluminium, or may be a ferrous material such as a stainless steel. The second susceptor material is preferably used primarily to indicate when the susceptor has reached a specific temperature, that temperature being the Curie temperature of the second susceptor material. The Curie temperature of the second susceptor material can be used to regulate the temperature of the entire susceptor during operation. Thus, the Curie temperature of the second susceptor material should be below the ignition point of the aerosol-generating substrate. Suitable materials for the second susceptor material may include nickel and certain nickel alloys.

By providing a susceptor having at least a first and a second susceptor material, with either the second susceptor material having a Curie temperature and the first susceptor material not having a Curie temperature, or first and second susceptor materials having first and second Curie temperatures distinct from one another, the heating of the aerosol-generating substrate and the temperature control of the heating may be separated. The first susceptor material is preferably a magnetic material having a Curie temperature that is above 500 degrees Celsius. It is desirable from the point of view of heating efficiency that the Curie temperature of the first susceptor material is above any maximum temperature that the susceptor should be capable of being heated to. The second Curie temperature may preferably be selected to be lower than 400 degrees Celsius, preferably lower than 380 degrees Celsius, or lower than 360 degrees Celsius. It is preferable that the second susceptor material is a magnetic material selected to have a second Curie temperature that is substantially the same as a desired maximum heating temperature. That is, it is preferable that the second Curie temperature is approximately the same as the temperature that the susceptor should be heated to in order to generate an aerosol from the aerosol-generating substrate. The second Curie temperature may, for example, be within the range of 200 degrees Celsius to 400 degrees Celsius, or between 250 degrees Celsius and 360 degrees Celsius. The second Curie temperature of the second susceptor material may, for example, be selected such that, upon being heated by a susceptor that is at a temperature equal to the second Curie temperature, an overall average temperature of the aerosol-generating substrate does not exceed 240 degrees Celsius.

In those embodiments where the susceptor is in the form of a strip or blade, a grammage of the susceptor may be at least about 350 grams per square metre, preferably at least about 400 grams per square metre, more preferably at least about 450 grams per square metre. Preferably, in such embodiments a grammage of the susceptor is less than or equal to about 650 grams per square metre, more preferably less than or equal to about 600 grams per square metre, even more preferably less than or equal to about 550 grams per square metre. In certain preferred embodiments, a grammage of the susceptor is about 500 grams per square metre.

In an aerosol-generating article in accordance with the present invention, the susceptor may have a density of at least about 5 grams per cubic centimetre, preferably at least about 6 grams per cubic centimetre, more preferably at least about 7 grams per cubic centimetre. The susceptor preferably has a density of less than or equal to about 11 grams per cubic centimetre, more preferably less than or equal to about 10 grams per cubic centimetre, even more preferably less than or equal to about 9 grams per cubic centimetre. In certain preferred embodiments, the susceptor has a density of about 8 grams per cubic centimetre.

In an aerosol-generating article according to the present invention, the susceptor is coated with a coating composition. As used herein, the term “coated” means that a layer including a coating composition has been provided on an outer surface of the susceptor. This is not limited by the mechanism or method of forming or applying the coating over the outer surface of the susceptor. By way of example, the coating composition may be applied on an outer surface of the susceptor through spraying, dip coating, extruding of the coating composition on the susceptor.

In some embodiments an entire outer surface of the susceptor is coated. This may also be described as a “continuous coating”. In other embodiments, only a portion of the outer surface of the susceptor is coated. This may also be described as a “discontinuous coating”, as the coating effectively forms areas of coverage and areas of no coverage on the outer surface of the susceptor.

Preferably, at least 50 percent of a surface area of an outer surface of the susceptor is coated with the coating composition. More preferably, at least 75 percent of a surface area of an outer surface of the susceptor is coated with the coating composition. Even more preferably, at least 90 percent of a surface area of an outer surface of the susceptor is coated with the coating composition. Most preferably, at least 95 percent of a surface area of an outer surface of the susceptor is coated with the coating composition. In some particularly preferred embodiments, substantially the entire surface area of an outer surface of the susceptor is coated with the coating composition.

The coating composition forms a layer on an outer surface of the susceptor. A thickness of the layer of coating composition may be controlled by adjusting parameters such as the viscosity of the slurry prior to starting the application process. Further, different application techniques, such as dipping and spraying, may be selectively used to control the thickness of the layer of coating composition.

A layer of the coating composition may have a thickness of at least 1 micrometre. Preferably, a layer of the coating composition has a thickness of at least 2 micrometres, more preferably at least 3 micrometres, even more preferably at least 4 micrometres. In particularly preferred embodiments, a layer of the coating composition has a thickness of at least about 5 micrometres, more preferably about 6 micrometres.

A layer of the coating composition may have a thickness up to about 100 micrometres. Preferably, a layer of the coating composition has a thickness of less than or equal to about 50 micrometres, more preferably less than or equal to about 30 micrometres, even more preferably less than or equal to about 15 micrometres. In particularly preferred embodiments, a layer of the coating composition has a thickness of less than or equal to about 12 micrometres, more preferably less than or equal to about 10 micrometres.

In some embodiments, a layer of the coating composition has a thickness from about 2 micrometres to about 50 micrometres, preferably from about 3 micrometres to about 50 micrometres, more preferably from about 4 micrometres to about 50 micrometres, even more preferably from about 5 micrometres to about 50 micrometres, most preferably from about 6 micrometres to about 50 micrometres. In other embodiments, a layer of the coating composition has a thickness from about 2 micrometres to about 30 micrometres, preferably from about 3 micrometres to about 30 micrometres, more preferably from about 4 micrometres to about 30 micrometres, even more preferably from about 5 micrometres to about 30 micrometres, most preferably from about 6 micrometres to about 30 micrometres. In further embodiments, a layer of the coating composition has a thickness from about 2 micrometres to about 15 micrometres, preferably from about 3 micrometres to about 15 micrometres, more preferably from about 4 micrometres to about 15 micrometres, even more preferably from about 5 micrometres to about micrometres, most preferably from about 6 micrometres to about 15 micrometres. In additional embodiments, a layer of the coating composition has a thickness from about 2 micrometres to about 12 micrometres, preferably from about 3 micrometres to about 12 micrometres, more preferably from about 4 micrometres to about 12 micrometres, even more preferably from about micrometres to about 30 micrometres, most preferably from about 6 micrometres to about 12 micrometres. In yet further embodiments, a layer of the coating composition has a thickness from about 2 micrometres to about 10 micrometres, preferably from about 3 micrometres to about 10 micrometres, more preferably from about 4 micrometres to about 10 micrometres, even more preferably from about 5 micrometres to about 10 micrometres, most preferably from about 6 micrometres to about 10 micrometres.

An overall weight of the coating composition present in an aerosol-generating article in accordance with the present invention may be from about 1 milligram to about 4 milligrams, preferably from about 1 milligram to about 3 milligrams, more preferably from about 1 milligram to about 2 milligrams.

The sum of an overall weight of the aerosol-generating substrate in the aerosol-generating element and of the overall weight of the coating composition in an aerosol-generating article in accordance with the present invention may be from about 150 milligrams to about 500 milligrams, preferably from about 180 milligrams to about 400 milligrams, more preferably from about 200 milligrams to about 300 milligrams. In certain preferred embodiments, the sum of an overall weight of the aerosol-generating substrate in the aerosol-generating element and of the overall weight of the coating composition is approximately 250 milligrams.

As mentioned previously, in aerosol-generating articles in accordance with the present invention, the coating composition comprises at least 20 percent by weight of an aerosol former. In addition, the coating composition comprises isolated nicotine or a monoprotic nicotine salt or both. Upon heating, the coating composition described herein is adapted provide a nicotine-containing aerosol to the lungs at inhalation or air flow rates that are within conventional smoking regime inhalation or air flow rates.

The coating composition preferably includes about 0.5 percent by weight to about 10 percent by weight of isolated nicotine or the monoprotic nicotine salt or both. More preferably, the coating composition includes about 1 percent by weight to about 3 percent by weight of isolated nicotine or the monoprotic nicotine salt or both. Even more preferably, the coating composition includes about 1.5 percent by weight to about 2.5 percent by weight of isolated nicotine or the monoprotic nicotine salt or both. In some preferred embodiments, the coating composition includes about 1.5 percent by weight of isolated nicotine or the monoprotic nicotine salt or both. The coating composition may include about 2 percent by weight of isolated nicotine or the monoprotic nicotine salt or both.

The nicotine component of the coating composition may be the most volatile component of the coating composition. In some aspects, water may be the most volatile component of the coating composition and the nicotine component of the coating composition may be the second most volatile component of the coating composition.

As described above, the aerosol-generating substrate comprises a homogenised tobacco material comprising aerosol former. Therefore, a total weight of nicotine in the aerosol-generating article will substantially correspond to the sum of the nicotine content in the coating composition and the nicotine content in the homogenised tobacco material. A nicotine content in the coating composition may account for at least about 0.1 percent by weight of a total nicotine content in the aerosol-generating article as a whole. Preferably, a nicotine content in the coating composition accounts for at least about 0.25 percent by weight of a total nicotine content in the aerosol-generating article as a whole. More preferably, a nicotine content in the coating composition accounts for at least about 0.5 percent by weight of a total nicotine content in the aerosol-generating article as a whole.

A nicotine content in the coating composition preferably accounts for less than or equal to about 10 percent by weight of a total nicotine content in the aerosol-generating article as a whole. More preferably, a nicotine content in the coating composition accounts for less than or equal to about 5 percent by weight of a total nicotine content in the aerosol-generating article as a whole. Even more preferably, a nicotine content in the coating composition accounts for less than or equal 2 percent by weight of a total nicotine content in the aerosol-generating article as a whole.

In some embodiments, a nicotine content in the coating composition preferably accounts for from about 0.1 to about 10 percent by weight of a total nicotine content in the aerosol-generating article as a whole. Preferably, a nicotine content in the coating composition preferably accounts for from about 0.25 to about 10 percent by weight of a total nicotine content in the aerosol-generating article as a whole. More preferably, a nicotine content in the coating composition preferably accounts for from about 0.5 to about 10 percent by weight of a total nicotine content in the aerosol-generating article as a whole. In other embodiments, a nicotine content in the coating composition preferably accounts for from about 0.1 to about 15 percent by weight of a total nicotine content in the aerosol-generating article as a whole. Preferably, a nicotine content in the coating composition preferably accounts for from about 0.25 to about 5 percent by weight of a total nicotine content in the aerosol-generating article as a whole. More preferably, a nicotine content in the coating composition preferably accounts for from about 0.5 to about 5 percent by weight of a total nicotine content in the aerosol-generating article as a whole. In further embodiments, a nicotine content in the coating composition preferably accounts for from about 0.1 to about 2 percent by weight of a total nicotine content in the aerosol-generating article as a whole. Preferably, a nicotine content in the coating composition preferably accounts for from about 0.25 to about 2 percent by weight of a total nicotine content in the aerosol-generating article as a whole. More preferably, a nicotine content in the coating composition preferably accounts for from about 0.5 to about 2 percent by weight of a total nicotine content in the aerosol-generating article as a whole.

The coating composition includes an aerosol former. Ideally the aerosol former is substantially resistant to thermal degradation at the operating temperature of the associated aerosol-generating device. Suitable aerosol formers include, but are not limited to: polyhydric alcohols, such as triethylene glycol, 1, 3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Polyhydric alcohols or mixtures thereof, may be one or more of triethylene glycol, 1, 3-butanediol and, glycerine (glycerol or propane-1,2,3-triol) or polyethylene glycol. The aerosol former is preferably glycerol.

As described briefly above, the coating composition comprises at least 20 percent by weight of the aerosol former. The coating composition may comprise from about 20 percent by weight of the aerosol former to about 90 percent by weight of the aerosol former, such as from about 30 percent by weight of the aerosol former to about 80 percent by weight of the aerosol former or from about 40 percent by weight of the aerosol former to 70 percent by weight of the aerosol former. In some preferred embodiments, the coating composition may comprise approximately 50 percent by weight of the aerosol former.

In particular, the composition may comprise from about 20 percent by weight of glycerol to about 90 percent by weight of glycerol, such as from about 30 percent by weight of glycerol to about 80 percent by weight of glycerol or from about 40 percent by weight of glycerol to 70 percent by weight of glycerol. In some preferred embodiments, the coating composition may comprise approximately 50 percent by weight of glycerol.

The coating composition may include a majority of an aerosol former. The coating composition may include a mixture of water and the aerosol former where the aerosol former forms a majority (by weight) of the coating composition. The aerosol former may form at least about 50 percent by weight of the coating composition. The aerosol former may form at least about 60 percent by weight or at least about 65 percent by weight or at least about 70 percent by weight of the coating composition. The aerosol former may form about 70 percent by weight to about 80 percent by weight of the coating composition. The aerosol former may form about 70 percent by weight to about 75 percent by weight of the coating composition.

The coating composition may, in particular, include a majority of glycerol. The coating composition may include a mixture of water and the glycerol where the glycerol forms a majority (by weight) of the coating composition. The glycerol may form at least about 50 percent by weight of the coating composition. The glycerol may form at least about 60 percent by weight or at least about 65 percent by weight or at least about 70 percent by weight of the coating composition. The glycerol may form about 70 percent by weight to about 80 percent by weight of the coating composition.

The glycerol may form about 70 percent by weight to about 75 percent by weight of the coating composition.

As described above, the aerosol-generating substrate comprises a homogenised tobacco material comprising aerosol former. Therefore, an overall content of aerosol former in the aerosol-generating article will substantially correspond to the sum of the aerosol former content in the coating composition and the aerosol former content in the homogenised tobacco material.

An aerosol former content in the coating composition may account for at least about 0.1 percent by weight of an overall aerosol former content in the aerosol-generating article as a whole. Preferably, an aerosol former content in the coating composition accounts for at least about 0.25 percent by weight of an overall aerosol former content in the aerosol-generating article as a whole. More preferably, an aerosol former content in the coating composition accounts for at least about percent by weight of an overall aerosol former content in the aerosol-generating article as a whole.

An aerosol former content in the coating composition preferably accounts for less than or equal to about 10 percent by weight of an overall aerosol former content in the aerosol-generating article as a whole. More preferably, an aerosol former content in the coating composition accounts for less than or equal to about 5 percent by weight of an overall aerosol former content in the aerosol-generating article as a whole. Even more preferably, an aerosol former content in the coating composition accounts for less than or equal 2 percent by weight of an overall aerosol former content in the aerosol-generating article as a whole.

In some embodiments, an aerosol former content in the coating composition preferably accounts for from about 0.1 to about 10 percent by weight of an overall aerosol former content in the aerosol-generating article as a whole. Preferably, an aerosol former content in the coating composition preferably accounts for from about 0.25 to about 10 percent by weight of an overall aerosol former content in the aerosol-generating article as a whole. More preferably, an aerosol former content in the coating composition preferably accounts for from about 0.5 to about 10 percent by weight of an overall aerosol former content in the aerosol-generating article as a whole. In other embodiments, an aerosol former content in the coating composition preferably accounts for from about 0.1 to about 15 percent by weight of an overall aerosol former content in the aerosol-generating article as a whole. Preferably, an aerosol former content in the coating composition preferably accounts for from about 0.25 to about 5 percent by weight of an overall aerosol former content in the aerosol-generating article as a whole. More preferably, an aerosol former content in the coating composition preferably accounts for from about 0.5 to about 5 percent by weight of an overall aerosol former content in the aerosol-generating article as a whole. In further embodiments, an aerosol former content in the coating composition preferably accounts for from about 0.1 to about 2 percent by weight of an overall aerosol former content in the aerosol-generating article as a whole. Preferably, an aerosol former content in the coating composition preferably accounts for from about 0.25 to about 2 percent by weight of an overall aerosol former content in the aerosol-generating article as a whole. More preferably, an aerosol former content in the coating composition preferably accounts for from about 0.5 to about 2 percent by weight of an overall aerosol former content in the aerosol-generating article as a whole.

In preferred embodiments, a glycerol content in the coating composition may account for at least about 0.1 percent by weight of an overall aerosol former content in the aerosol-generating article as a whole. Preferably, a glycerol content in the coating composition accounts for at least about 0.25 percent by weight of an overall aerosol former content in the aerosol-generating article as a whole. More preferably, a glycerol content in the coating composition accounts for at least about 0.5 percent by weight of an overall aerosol former content in the aerosol-generating article as a whole.

A glycerol content in the coating composition preferably accounts for less than or equal to about 10 percent by weight of an overall aerosol former content in the aerosol-generating article as a whole. More preferably, a glycerol content in the coating composition accounts for less than or equal to about 5 percent by weight of an overall aerosol former content in the aerosol-generating article as a whole. Even more preferably, a glycerol content in the coating composition accounts for less than or equal 2 percent by weight of an overall aerosol former content in the aerosol-generating article as a whole.

In some preferred embodiments, a glycerol content in the coating composition preferably accounts for from about 0.1 to about 10 percent by weight of an overall aerosol former content in the aerosol-generating article as a whole. Preferably, a glycerol content in the coating composition preferably accounts for from about 0.25 to about 10 percent by weight of an overall aerosol former content in the aerosol-generating article as a whole. More preferably, a glycerol content in the coating composition preferably accounts for from about 0.5 to about 10 percent by weight of an overall aerosol former content in the aerosol-generating article as a whole. In other embodiments, a glycerol content in the coating composition preferably accounts for from about to about 15 percent by weight of an overall aerosol former content in the aerosol-generating article as a whole. Preferably, a glycerol content in the coating composition preferably accounts for from about 0.25 to about 5 percent by weight of an overall aerosol former content in the aerosol-generating article as a whole. More preferably, a glycerol content in the coating composition preferably accounts for from about 0.5 to about 5 percent by weight of an overall aerosol former content in the aerosol-generating article as a whole. In further embodiments, a glycerol content in the coating composition preferably accounts for from about 0.1 to about 2 percent by weight of an overall aerosol former content in the aerosol-generating article as a whole. Preferably, a glycerol content in the coating composition preferably accounts for from about 0.25 to about 2 percent by weight of an overall aerosol former content in the aerosol-generating article as a whole. More preferably, a glycerol content in the coating composition preferably accounts for from about 0.5 to about 2 percent by weight of an overall aerosol former content in the aerosol-generating article as a whole.

In certain preferred embodiments of the present invention, the coating composition further includes at least one gelling agent. In other words, the coating composition is preferably a gel composition. Preferably, the at least one gelling agent forms a solid medium and the aerosol former is dispersed in the solid medium, with the isolated nicotine or the monoprotic nicotine salt or both being dispersed in the aerosol former.

The term “gelling agent” refers to a compound that homogeneously, when added to a 50 percent by weight water/50 percent by weight glycerol mixture, in an amount of about 0.3 percent by weight, forms a solid medium or support matrix leading to a gel. Gelling agents include, but are not limited to, hydrogen-bond crosslinking gelling agents, and ionic crosslinking gelling agents.

The gelling agent may include one or more biopolymers. The biopolymers may be formed of polysaccharides.

Biopolymers include, for example, gellan gums (native, low acyl gellan gum, high acyl gellan gums with low acyl gellan gum being preferred), xanthan gum, alginates (alginic acid), agar, guar gum, and the like. The composition may preferably include xanthan gum. The composition may include two biopolymers. The composition may include three biopolymers. The composition may include the two biopolymers in substantially equal weights. The composition may include the three biopolymers in substantially equal weights.

Preferably, the gel composition is a stable gel phase. Advantageously, a stable gel composition comprising nicotine provides a predictable composition form upon storage or transit from manufacture to the consumer. The stable gel composition comprising nicotine substantially maintains its shape. The stable gel composition comprising nicotine substantially does not release a liquid phase upon storage or transit from manufacture to the consumer. The stable gel composition comprising nicotine may provide for a simple consumable design. This consumable may not have to be designed to contain a liquid, thus a wider range of materials and container constructions may be contemplated.

The phrase “stable gel phase” or “stable gel” refers to gel that substantially maintains its shape and mass when exposed to a variety of environmental conditions. The stable gel may not substantially release (sweat) or absorb water when exposed to a standard temperature and pressure while varying relative humidity from about 10 percent to about 60 percent. For example, the stable gel may substantially maintain its shape and mass when exposed to a standard temperature and pressure while varying relative humidity from about 10 percent to about 60 percent.

The coating composition preferably includes one or more gelling agents. In certain preferred embodiments, the gelling agent comprises carboxymethyl cellulose (CMC) or hydroxypropyl methylcellulose (HPMC) or both. Preferably, in these embodiments the aerosol former comprises glycerol.

Preferably, the coating composition includes a total amount of gelling agents in a range from about 0.4 percent by weight to about 10 percent by weight. More preferably, the coating composition includes the gelling agents in a range from about 0.5 percent by weight to about 8 percent by weight. More preferably, the coating composition includes the gelling agents in a range from about 1 percent by weight to about 6 percent by weight. More preferably, the coating composition includes the gelling agents in a range from about 2 percent by weight to about 4 percent by weight. More preferably, the coating composition includes the gelling agents in a range from about 2 percent by weight to about 3 percent by weight.

The aerosol-generating article of the invention preferably further comprises a downstream section at a location downstream of the aerosol-generating element. As will become apparent from the following description of different embodiments of the aerosol-generating article of the invention, the downstream section may comprise one or more downstream elements.

The downstream section may comprise a support element arranged in alignment with, and downstream of the aerosol-generating element. In particular, the support element may be located immediately downstream of the aerosol-generating element and may abut the rod of aerosol-generating substrate.

The support element may be formed from any suitable material or combination of materials. For example, the support element may be formed from one or more materials selected from the group consisting of: cellulose acetate; cardboard; crimped paper, such as crimped heat resistant paper or crimped parchment paper; and polymeric materials, such as low density polyethylene (LDPE). In a preferred embodiment, the support element is formed from cellulose acetate. Other suitable materials include polyhydroxyalkanoate (PHA) fibres.

The support element may comprise a hollow tubular segment. In a preferred embodiment, the support element comprises a hollow cellulose acetate tube.

The support element is arranged substantially in alignment with the rod. This means that the length dimension of the support element is arranged to be approximately parallel to the longitudinal direction of the rod and of the article, for example within plus or minus 10 degrees of parallel to the longitudinal direction of the rod. In preferred embodiments, the support element extends along the longitudinal axis of the rod.

The support element preferably has an outer diameter that is approximately equal to the outer diameter of the rod of aerosol-generating substrate and to the outer diameter of the aerosol-generating article.

The support element may have an outer diameter of between 5 millimetres and 12 millimetres, for example of between 5 millimetres and 10 millimetres or of between 6 millimetres and 8 millimetres. In a preferred embodiment, the support element has an external diameter of 7.2 millimetres plus or minus 10 percent.

A peripheral wall of the support element may have a thickness of at least 1 millimetre, preferably at least about 1.5 millimetres, more preferably at least about 2 millimetres.

The support element may have a length of between about 5 millimetres and about 15 millimetres.

Preferably, the support element has a length of at least about 6 millimetres, more preferably at least about 7 millimetres.

In preferred embodiments, the support element has a length of less than about 12 millimetres, more preferably less than about 10 millimetres.

In some embodiments, the support element has a length from about 5 millimetres to about millimetres, preferably from about 6 millimetres to about 15 millimetres, more preferably from about 7 millimetres to about 15 millimetres. In other embodiments, the support element has a length from about 5 millimetres to about 12 millimetres, preferably from about 6 millimetres to about 12 millimetres, more preferably from about 7 millimetres to about 12 millimetres. In further embodiments, the support element has a length from about 5 millimetres to about 10 millimetres, preferably from about 6 millimetres to about 10 millimetres, more preferably from about 7 millimetres to about 10 millimetres.

In a preferred embodiment, the support element has a length of about 8 millimetres.

Preferably, the total length of the intermediate hollow section is no more than about 18 millimetres, more preferably no more than about 17 millimetres, more preferably no more than 16 millimetres.

Preferably, in aerosol-generating articles in accordance with the present invention the support element has an average radial hardness of at least about 80 percent, more preferably at least about 85 percent, even more preferably at least about 90 percent. The support element is therefore able to provide a desirable level of hardness to the aerosol-generating article. If desired, the radial hardness of a component, such as the support element, of the downstream section of aerosol-generating articles in accordance with the invention may be further increased by circumscribing the aerosol-cooling element by a stiff plug wrap, for example, a plug wrap having a basis weight of at least about 80 grams per square metre (gsm), or at least about 100 gsm, or at least about 110 gsm.

As used herein, the term “radial hardness” refers to resistance to compression in a direction transverse to a longitudinal axis of the support element. Radial hardness of an aerosol-generating article around a support element may be determined by applying a load across the article at the location of the support element, transverse to the longitudinal axis of the article, and measuring the average (mean) depressed diameters of the articles. Radial hardness is given by:

Radial hardness (%)=(D_{d}/D_{S})*100
where D_{S} is the original (undepressed) diameter, and D_{d} is the depressed diameter after applying a set load for a set duration. The harder the material, the closer the hardness is to 100 percent.

To determine the hardness of a portion (such as a support element provided in the form of a hollow tube segment) of an aerosol article, aerosol-generating articles should be aligned parallel in a plane and the same portion of each aerosol-generating article to be tested should be subjected to a set load for a set duration. This test is performed using a known DD60A Densimeter device (manufactured and made commercially available by Heinr Borgwaldt GmbH, Germany), which is fitted with a measuring head for aerosol-generating articles, such as cigarettes, and with an aerosol-generating article receptacle.

The load is applied using two load-applying cylindrical rods, which extend across the diameter of all of the aerosol-generating articles at once. According to the standard test method for this instrument, the test should be performed such that twenty contact points occur between the aerosol-generating articles and the load applying cylindrical rods. In some cases, the hollow tube segments to be tested may be long enough such that only ten aerosol-generating articles are needed to form twenty contact points, with each smoking article contacting both load applying rods (because they are long enough to extend between the rods). In other cases, if the support elements are too short to achieve this, then twenty aerosol-generating articles should be used to form the twenty contact points, with each aerosol-generating article contacting only one of the load applying rods, as further discussed below.

Two further stationary cylindrical rods are located underneath the aerosol-generating articles, to support the aerosol-generating articles and counteract the load applied by each of the load applying cylindrical rods.

For the standard operating procedure for such an apparatus, an overall load of 2 kg is applied for a duration of 20 seconds. After 20 seconds have elapsed (and with the load still being applied to the smoking articles), the depression in the load applying cylindrical rods is determined, and then used to calculate the hardness from the above equation. The temperature is kept in the region of 22 degrees Celsius±2 degrees. The test described above is referred to as the DD60A Test. The standard way to measure the filter hardness is when the aerosol-generating article have not been consumed. Additional information regarding measurement of average radial hardness can be found in, for example, U.S. Published Patent Application Publication Number 2016/0128378.

During insertion of an aerosol-generating article in accordance with the invention into an aerosol-generating device for heating the aerosol-generating substrate, a user may be required to apply some force in order to overcome the resistance of the aerosol-generating substrate of the aerosol-generating article to insertion. This may damage one or both of the aerosol-generating article and the aerosol-generating device. In addition, the application of force during insertion of the aerosol-generating article into the aerosol-generating device may displace the aerosol-generating substrate within the aerosol-generating article. This may result in the heating element of the aerosol-generating device not being properly aligned with the susceptor provided within the aerosol-generating substrate, which may lead to uneven and inefficient heating of the aerosol-generating substrate of the aerosol-generating article. The support element is advantageously configured to resist downstream movement of the aerosol-generating substrate during insertion of the article into the aerosol-generating device.

Preferably, the hollow tubular segment of the support element is adapted to generate a RTD between approximately 0 millimetres H₂O (about 0 Pa) to approximately 20 millimetres H₂O (about 100 Pa), more preferably between approximately 0 millimetres H₂O (about 0 Pa) to approximately 10 millimetres H₂O (about 100 Pa). The support element therefore preferably does not contribute to the overall RTD of the aerosol-generating article.

In certain preferred embodiments, the downstream section of the aerosol-generating article comprises a mouthpiece element positioned downstream of the aerosol-generating element and in longitudinal alignment with the aerosol-generating element.

The mouthpiece element is preferably located at the downstream end or mouth end of the aerosol-generating article, and extends all the way to the mouth end of the aerosol-generating article.

Preferably, the mouthpiece element comprises at least one mouthpiece filter segment of a fibrous filtration material for filtering the aerosol that is generated from the aerosol-generating substrate. Suitable fibrous filtration materials would be known to the skilled person. Particularly preferably, the at least one mouthpiece filter segment comprises a cellulose acetate filter segment formed of cellulose acetate tow.

The mouthpiece element may consist of a single mouthpiece filter segment. The mouthpiece element may include two or more mouthpiece filter segments axially aligned in an abutting end to end relationship with each other.

The downstream section may comprise a mouth end cavity at the downstream end, downstream of the mouthpiece element as described above. The mouth end cavity may be defined by a hollow tubular element provided at the downstream end of the mouthpiece. The mouth end cavity may be defined by the outer wrapper of the mouthpiece element, wherein the outer wrapper extends in a downstream direction from the mouthpiece element.

The mouthpiece element may optionally comprise a flavourant, which may be provided in any suitable form. For example, the mouthpiece element may comprise one or more capsules, beads or granules of a flavourant, or one or more flavour loaded threads or filaments.

In an aerosol-generating article in accordance with the present invention the mouthpiece element forms a part of the downstream section and is therefore located downstream of the aerosol-generating element.

In certain preferred embodiments, the downstream section of the aerosol-generating article further comprises both a support element located immediately downstream of the aerosol-generating element and a mouthpiece element located downstream of the support element.

Preferably, the mouthpiece element has a low particulate filtration efficiency.

Preferably, the mouthpiece is formed of a segment of a fibrous filtration material.

Preferably, the mouthpiece element is circumscribed by a plug wrap. Preferably, the mouthpiece element is unventilated such that air does not enter the aerosol-generating article along the mouthpiece element.

The mouthpiece element is preferably connected to one or more of the adjacent upstream components of the aerosol-generating article by means of a tipping wrapper.

Preferably, the mouthpiece element has an RTD of less than about 25 millimetres H₂O. More preferably, the mouthpiece element has an RTD of less than about 20 millimetres H₂O. Even more preferably, the mouthpiece element has an RTD of less than about 15 millimetres H₂O.

Values of RTD from about 10 millimetres H₂O to about to about 15 millimetres H₂O are particularly preferred because a mouthpiece element having one such RTD is expected to contribute minimally to the overall RTD of the aerosol-generating article substantially does not exert a filtration action on the aerosol being delivered to the consumer.

The mouthpiece element preferably has an external diameter that is approximately equal to the external diameter of the aerosol-generating article. The mouthpiece element may have an external diameter of between about 5 millimetres and about 10 millimetres, or between about 6 millimetres and about 8 millimetres. In a preferred embodiment, the mouthpiece element has an external diameter of approximately 7.2 millimetres.

The mouthpiece element preferably has a length of at least about 5 millimetres, more preferably at least about 8 millimetres, more preferably at least about 10 millimetres. The mouthpiece element preferably has a length of less than about 25 millimetres, more preferably less than about 20 millimetres, more preferably less than about 15 millimetres.

In some embodiments, the mouthpiece element preferably has a length from about 5 millimetres to about 25 millimetres, more preferably from about 8 millimetres to about 25 millimetres, even more preferably from about 10 millimetres to about 25 millimetres. In other embodiments, the mouthpiece element preferably has a length from about 5 millimetres to about millimetres, more preferably from about 8 millimetres to about 20 millimetres, even more preferably from about 10 millimetres to about 20 millimetres. In further embodiments, the mouthpiece element preferably has a length from about 5 millimetres to about 15 millimetres, more preferably from about 8 millimetres to about 15 millimetres, even more preferably from about millimetres to about 15 millimetres.

For example, the mouthpiece element may have a length of between about 5 millimetres and about 25 millimetres, or between about 8 millimetres and about 20 millimetres, or between about 10 millimetres and about 15 millimetres. In a preferred embodiment, the mouthpiece element has a length of approximately 12 millimetres.

In particularly preferred embodiments, the downstream section may further comprise an aerosol-cooling element located downstream of the support element, with the mouthpiece element located downstream of both the support element and the aerosol-cooling element. Particularly preferably, the mouthpiece element is located immediately downstream of the aerosol-cooling element. By way of example, the mouthpiece element may abut the downstream end of the aerosol-cooling element.

The aerosol-cooling element may for example define a plurality of longitudinally extending channels such as to make a high surface area available for heat exchange. The plurality of longitudinally extending channels may be defined by a sheet material that has been pleated, gathered or folded to form the channels. The plurality of longitudinally extending channels may be defined by a single sheet that has been pleated, gathered or folded to form multiple channels. The sheet may also have been crimped prior to being pleated, gathered or folded. Alternatively, the plurality of longitudinally extending channels may be defined by multiple sheets that have been crimped, pleated, gathered or folded to form multiple channels. In some embodiments, the plurality of longitudinally extending channels may be defined by multiple sheets that have been crimped, pleated, gathered or folded together—that is by two or more sheets that have been brought into overlying arrangement and then crimped, pleated, gathered or folded as one.

One such aerosol-cooling element may have a total surface area of between about 300 square millimetre per millimetre length and about 1000 square millimetres per millimetre length.

One such aerosol-cooling element preferably offers a low resistance to the passage of air through additional cooling element. Preferably, the aerosol-cooling element does not substantially affect the resistance to draw of the aerosol-generating article. The aerosol-cooling element preferably comprises a sheet material selected from the group comprising a metallic foil, a polymeric sheet, and a substantially non-porous paper or cardboard. In some embodiments, the aerosol-cooling element may comprise a sheet material selected from the group consisting of polyethylene (PE), polypropylene (PP), polyvinylchloride (PVC), polyethylene terephthalate (PET), polylactic acid (PLA), cellulose acetate (CA), and aluminium foil. In a particularly preferred embodiment, the additional cooling element comprises a sheet of PLA.

The aerosol-generating article may further comprise an upstream section at a location upstream of the aerosol-generating element. The upstream section may comprise one or more upstream elements. In some embodiments, the upstream section may comprise an upstream element arranged immediately upstream of the aerosol-generating element.

The aerosol-generating article of the present invention preferably comprise an upstream element located upstream of and adjacent to the aerosol-generating element, wherein the upstream section comprises at least one upstream element. The upstream element advantageously prevents direct physical contact with the upstream end of the aerosol-generating substrate. In particular, the upstream element may prevent direct physical contact with the upstream end of the susceptor element provided within the aerosol-generating element. This helps to prevent the displacement or deformation of the susceptor element during handling or transport of the aerosol-generating article. This in turn helps to secure the form and position of the susceptor element. Furthermore, the presence of an upstream element helps to prevent any loss of the substrate.

The upstream element may also provide an improved appearance to the upstream end of the aerosol-generating article. Furthermore, if desired, the upstream element may be used to provide information on the aerosol-generating article, such as information on brand, flavour, content, or details of the aerosol-generating device that the article is intended to be used with.

The upstream element may be a porous plug element. Preferably, a porous plug element does not alter the resistance to draw of the aerosol-generating article. Preferably, the upstream element has a porosity of at least about 50 percent in the longitudinal direction of the aerosol-generating article. More preferably, the upstream element has a porosity of between about 50 percent and about 90 percent in the longitudinal direction. The porosity of the upstream element in the longitudinal direction is defined by the ratio of the cross-sectional area of material forming the upstream element and the internal cross-sectional area of the aerosol-generating article at the position of the upstream element.

The upstream element may be made of a porous material or may comprise a plurality of openings. This may, for example, be achieved through laser perforation. Preferably, the plurality of openings is distributed homogeneously over the cross-section of the upstream element.

The porosity or permeability of the upstream element may advantageously be varied in order to provide a desirable overall resistance to draw of the aerosol-generating article.

Preferably, the RTD of the upstream element is at least about 5 millimetres H₂O. More preferably, the RTD of the upstream element is at least about 10 millimetres H₂O. Even more preferably, the RTD of the upstream element is at least about 15 millimetres H₂O. In particularly preferred embodiments, the RTD of the upstream element is at least about 20 millimetres H₂O.

The RTD of the upstream element is preferably less than or equal to about 80 millimetres H₂O. More preferably, the RTD of the upstream element is less than or equal to about 60 millimetres H₂O. Even more preferably, the RTD of the upstream element is less than or equal to about 40 millimetres H₂O.

In some embodiments, the RTD of the upstream element is from about 5 millimetres H₂O to about 80 millimetres H₂O, preferably from about 10 millimetres H₂O to about 80 millimetres H₂O, more preferably from about 15 millimetres H₂O to about 80 millimetres H₂O, even more preferably from about 20 millimetres H₂O to about 80 millimetres H₂O. In other embodiments, the RTD of the upstream element is from about 5 millimetres H₂O to about 60 millimetres H₂O, preferably from about 10 millimetres H₂O to about 60 millimetres H₂O, more preferably from about 15 millimetres H₂O to about 60 millimetres H₂O, even more preferably from about 20 millimetres H₂O to about 60 millimetres H₂O. In further embodiments, the RTD of the upstream element is from about 5 millimetres H₂O to about 40 millimetres H₂O, preferably from about 10 millimetres H₂O to about 40 millimetres H₂O, more preferably from about 15 millimetres H₂O to about 40 millimetres H₂O, even more preferably from about 20 millimetres H₂O to about 40 millimetres H₂O.

The upstream element may be formed from a material that is impermeable to air. The aerosol-generating article may be configured such that air flows into the rod of aerosol-generating substrate through suitable ventilation means provided in a wrapper.

The upstream element may be made of any material suitable for use in an aerosol-generating article. The upstream element may, for example, be made of a same material as used for one of the other components of the aerosol-generating article, such as the mouthpiece, the cooling element or the support element. Suitable materials for forming the upstream element include filter materials, ceramic, polymer material, cellulose acetate, cardboard, zeolite or aerosol-generating substrate. Preferably, the upstream element is formed from a plug of cellulose acetate.

Preferably, the upstream element is formed of a heat resistant material. For example, preferably the upstream element is formed of a material that resists temperatures of up to 350 degrees Celsius. This ensures that the upstream element is not adversely affected by the heating means for heating the aerosol-generating substrate.

Preferably, the upstream element has a diameter that is approximately equal to the diameter of the aerosol-generating article.

Preferably, the upstream element has a length of between about 1 millimetre and about millimetres, more preferably between about 3 millimetres and about 8 millimetres, more preferably between about 4 millimetres and about 6 millimetres. In a particularly preferred embodiment, the upstream element has a length of about 5 millimetres. The length of the upstream element can advantageously be varied in order to provide the desired total length of the aerosol-generating article. For example, where it is desired to reduce the length of one of the other components of the aerosol-generating article, the length of the upstream element may be increased in order to maintain the same overall length of the article.

The upstream element preferably has a substantially homogeneous structure. For example, the upstream element may be substantially homogeneous in texture and appearance. The upstream element may, for example, have a continuous, regular surface over its entire cross section. The upstream element may, for example, have no recognisable symmetries.

The upstream element is preferably circumscribed by a wrapper. The wrapper circumscribing the upstream element is preferably a stiff plug wrap, for example, a plug wrap having a basis weight of at least about 80 grams per square metre (gsm), or at least about 100 gsm, or at least about 110 gsm. This provides structural rigidity to the upstream element.

The aerosol-generating article may have a length from about 35 millimetres to about 100 millimetres.

The aerosol-generating article may have a length from about 35 millimetres to about 100 millimetres.

Preferably, an overall length of an aerosol-generating article in accordance with the invention is at least about 38 millimetres. More preferably, an overall length of an aerosol-generating article in accordance with the invention is at least about 40 millimetres. Even more preferably, an overall length of an aerosol-generating article in accordance with the invention is at least about 42 millimetres.

An overall length of an aerosol-generating article in accordance with the invention is preferably less than or equal to 70 millimetres. More preferably, an overall length of an aerosol-generating article in accordance with the invention is preferably less than or equal to 60 millimetres. Even more preferably, an overall length of an aerosol-generating article in accordance with the invention is preferably less than or equal to 50 millimetres.

In some embodiments, an overall length of the aerosol-generating article is preferably from about 38 millimetres to about 70 millimetres, more preferably from about 40 millimetres to about 70 millimetres, even more preferably from about 42 millimetres to about 70 millimetres. In other embodiments, an overall length of the aerosol-generating article is preferably from about 38 millimetres to about 60 millimetres, more preferably from about 40 millimetres to about 60 millimetres, even more preferably from about 42 millimetres to about 60 millimetres. In further embodiments, an overall length of the aerosol-generating article is preferably from about 38 millimetres to about 50 millimetres, more preferably from about 40 millimetres to about 50 millimetres, even more preferably from about 42 millimetres to about 50 millimetres. In an exemplary embodiment, an overall length of the aerosol-generating article is about 45 millimetres.

The aerosol-generating article has an external diameter of at least 5 millimetres. Preferably, the aerosol-generating article has an external diameter of at least 6 millimetres. More preferably, the aerosol-generating article has an external diameter of at least 7 millimetres.

Preferably, the aerosol-generating article has an external diameter of less than or equal to about 12 millimetres. More preferably, the aerosol-generating article has an external diameter of less than or equal to about 10 millimetres. Even more preferably, the aerosol-generating article has an external diameter of less than or equal to about 8 millimetres.

In some embodiments, the aerosol-generating article has an external diameter from about millimetres to about 12 millimetres, preferably from about 6 millimetres to about 12 millimetres, more preferably from about 7 millimetres to about 12 millimetres. In other embodiments, the aerosol-generating article has an external diameter from about 5 millimetres to about 10 millimetres, preferably from about 6 millimetres to about 10 millimetres, more preferably from about 7 millimetres to about 10 millimetres. In further embodiments, the aerosol-generating article has an external diameter from about 5 millimetres to about 8 millimetres, preferably from about 6 millimetres to about 8 millimetres, more preferably from about 7 millimetres to about 8 millimetres.

Preferably, an aerosol-generating article in accordance with the present invention comprises, in linear sequential arrangement, an upstream element, an aerosol-generating element located immediately downstream of the upstream element, a support element located immediately downstream of the aerosol-generating element, a mouthpiece element located immediately downstream of the support element, and an outer wrapper circumscribing the upstream element, the aerosol-generating element, the support element, and the mouthpiece element.

In more detail, the aerosol-generating element may abut the upstream element. The support element may abut the aerosol-generating element. The aerosol-cooling element may abut the support element. The mouthpiece element may abut the aerosol-cooling element.

The aerosol-generating article has a substantially cylindrical shape and an outer diameter of about 7.25 millimetres.

The upstream element has a length of about 5 millimetres, the aerosol-generating element has a length of about 12 millimetres, the support element has a length of about 16 millimetres, the mouthpiece element has a length of about 12 millimetres. Thus, an overall length of the aerosol-generating article is about 45 millimetres.

The upstream element is in the form of a plug of cellulose acetate wrapped in stiff plug wrap.

The aerosol-generating article comprises an elongate susceptor arranged substantially longitudinally within the aerosol-generating substrate, and is thermally coupled with the aerosol-generating substrate. The susceptor is in the form of a strip or blade, has a length substantially equal to the length of the aerosol-generating element and a thickness of about 60 micrometres.

The support element is in the form of a hollow cellulose acetate tube and has an internal diameter of about 1.9 millimetres. Thus, a thickness of a peripheral wall of the support element is about 2.675 millimetres.

The mouthpiece is in the form of a low-density cellulose acetate filter segment.

The aerosol-generating substrate comprises homogenised tobacco.

A coating composition covers the majority of an outer surface of the susceptor, preferably substantially the whole of an outer surface of the susceptor.

As mentioned briefly above, aerosol-generating articles in accordance with the present invention may be manufactured at high speed by implementing suitable methods on existing equipment without requiring a too significant modification thereof.

In one such method, in a first step there is provided an aerosol-generating substrate comprising a homogenised tobacco material comprising aerosol former. In a second step, there is provided a protected coated susceptor, wherein the protected coated susceptor comprises a susceptor element coated with a coating composition comprising aerosol former and isolated nicotine or a monoprotic nicotine salt or both, and a protective layer applied over the coating composition. In a third step, the protective layer is removed to expose the coating composition and provide an unprotected coated susceptor. In a fourth step, the unprotected coated susceptor and the aerosol-generating substrate to form an aerosol-generating element, such that the unprotected coated susceptor is arranged within the aerosol-generating element and configured to heat the homogenised tobacco material in the aerosol-generating substrate.

According to this method it is advantageously possible to store the coated susceptor in a protected state, wherein the coating composition is efficiently preserved. Because the protective layer can be removed only immediately prior to combining the coated susceptor with the aerosol-generating substrate to form the aerosol-generating element, the coating composition is advantageously protected, for example during storage or transportation, against dust or other potential contaminants. Further, the provision of one such protective layer may prevent layers of the coated susceptor from sticking to each other, if for example the coated susceptor is supplied wound in a bobbin. The protective layer may for example be in the form of a metallic foil, such as aluminium foil, and may be removed mechanically. In an embodiment, a continuous strip of protected coated susceptor may be supplied to advance through a foil-removing unit where the protective layer is removed, such as by wedges, and wound. The continuous strip of coated susceptor exiting the foil-removing unit may be supplied into a cone or funnel along with a sheet of homogenised tobacco material and a sheet of wrapper material to be combined into a continuous rod which may subsequently be cut into segments having a predetermined length.

In another one of such suitable methods, in a first step there is provided an aerosol-generating substrate comprising a homogenised tobacco material comprising aerosol former. In a second step, there is provided a susceptor element. In a third step, the susceptor element is coated with a coating composition comprising aerosol former and isolated nicotine or a monoprotic nicotine salt or both to provide a coated susceptor. In a fourth step, the coated susceptor and the aerosol-generating substrate to form an aerosol-generating element, such that the coated susceptor is arranged within the aerosol-generating element and configured to heat the homogenised tobacco material.

According to this method, the coating composition may be applied on the outer surface of the susceptor element at the same premises where the coated susceptor and the aerosol-generating substrate are combined. This may be achieved by dispensing the coating composition onto metal strip forming the susceptor element. The coated susceptor thus formed may be fed into a cone or funnel along with a sheet of homogenised tobacco material and a sheet of wrapper material to provide a continuous semi-finished rod which may subsequently be cut into segments having a predetermined length.

The invention is defined in the claims. However, below there is provided a non-exhaustive list of non-limiting examples. Any one or more of the features of these examples may be combined with any one or more features of another example, embodiment, or aspect described herein.

Example 1. An aerosol-generating article for producing an inhalable aerosol upon heating, the aerosol-generating article comprising: an aerosol-generating element comprising aerosol-generating substrate, wherein the aerosol-generating substrate comprises a homogenised tobacco material comprising aerosol former; and a susceptor arranged within the aerosol-generating element and configured to heat the homogenised tobacco material, the susceptor being coated with a coating composition comprising at least 20 percent by weight of an aerosol former, the coating composition further comprising isolated nicotine or a monoprotic nicotine salt or both.

Example 2. An aerosol-generating article according to Example 1, wherein the susceptor is surrounded by the homogenised tobacco material.

Example 3. An aerosol-generating article according to Example 1 or 2, wherein the susceptor is an elongate susceptor and extends longitudinally within the aerosol-generating element.

Example 4. An aerosol-generating article according to any one of Examples 1 to 3, wherein the homogenised tobacco material is provided as a gathered sheet of homogenised tobacco material.

Example 5. An aerosol-generating article according to any one of the preceding Examples, wherein the coating composition comprises at least one gelling agent that forms a solid medium, the aerosol former being dispersed in the solid medium, with the isolated nicotine or monoprotic nicotine salt or both dispersed in the aerosol former.

Example 6. An aerosol-generating article according to Example 5, wherein the gelling agent comprises carboxymethyl cellulose (CMC) or hydroxypropyl methylcellulose (HPMC) or both and the aerosol former comprises glycerol.

Example 7. An aerosol-generating article according to any one of the preceding Examples, wherein the aerosol former accounts for at least about 50 percent by weight of the coating composition.

Example 8. An aerosol-generating article according to any one of the preceding Examples, wherein the isolated nicotine or nicotine salt or both accounts for at least about 0.5 percent by weight of the coating composition.

Example 9. An aerosol-generating article according to any one of the preceding Examples, wherein the coating composition forms a layer on an outer surface of the susceptor, the layer having a thickness of at least about 1 micrometre.

Example 10. An aerosol-generating article according to any one of the preceding Examples, wherein a content of aerosol former in the coating composition amounts for at least about 0.25 percent of an overall content of aerosol former in the aerosol-generating article.

Example 11. An aerosol-generating article according to any one of the preceding Examples, comprising a downstream section at a location downstream of the aerosol-generating element, wherein the downstream section comprises a support element located immediately downstream of the aerosol-generating element, the support element being in longitudinal alignment with the aerosol-generating element and comprising a hollow tubular segment.

Example 12. An aerosol-generating article according to Example 11, comprising a mouthpiece element at a location downstream of the support element.

Example 13. An aerosol-generating article according to any one of the preceding Examples, comprising an upstream section at a location upstream of the aerosol-generating element, the upstream section comprising an upstream element positioned immediately upstream of the aerosol-generating element and having a resistance to draw (RTD) of less than about 80 millimetres H₂O.

Example 14. A method of manufacturing an aerosol-generating article for generating an inhalable aerosol upon heating, the method comprising: providing an aerosol-generating substrate comprising a homogenised tobacco material comprising aerosol former; providing a protected coated susceptor, wherein the protected coated susceptor comprises a susceptor element coated with a coating composition comprising aerosol former and isolated nicotine or a monoprotic nicotine salt or both, and a protective layer applied over the coating composition; removing the protective layer to expose the coating composition and provide an unprotected coated susceptor; combining the unprotected coated susceptor and the aerosol-generating substrate to form an aerosol-generating element, such that the unprotected coated susceptor is arranged within the aerosol-generating element and configured to heat the homogenised tobacco material.

Example 15. A method of manufacturing an aerosol-generating article for generating an inhalable aerosol upon heating, the method comprising: providing an aerosol-generating substrate comprising a homogenised tobacco material comprising aerosol former; providing a susceptor element; coating the susceptor element with a coating composition comprising aerosol former and isolated nicotine or a monoprotic nicotine salt or both to provide a coated susceptor; combining the coated susceptor and the aerosol-generating substrate to form an aerosol-generating element, such that the coated susceptor is arranged within the aerosol-generating element and configured to heat the homogenised tobacco material.

In the following, the invention will be further described with reference to the drawings of the accompanying Figures, wherein:

FIG. 1 shows qualitatively hoe aerosol delivery varies over time during use of an aerosol-generating article in accordance with the present invention;

FIG. 2 shows a schematic side sectional view of an aerosol-generating article in accordance with the invention; and

FIG. 3 shows a schematic perspective view of a coated susceptor for use in an aerosol-generating article in accordance with the invention.

The aerosol-generating article 10 shown in FIG. 2 comprises an aerosol-generating element 12 which comprises aerosol-generating substrate, and a downstream section 14 at a location downstream of the aerosol-generating element 12. Further, the aerosol-generating article 10 comprises an upstream section 16 at a location upstream of the aerosol-generating element 12. Thus, the aerosol-generating article 10 extends from an upstream or distal end 18 to a downstream or mouth end 20.

The aerosol-generating article has an overall length of about 45 millimetres.

The downstream section 14 comprises a support element 22 located immediately downstream of the aerosol-generating element 12, the support element 22 being in longitudinal alignment with the aerosol-generating element 12. In the embodiment of FIG. 2, the upstream end of the support element 18 abuts the downstream end of the aerosol-generating element 12.

The support element 22 comprises a hollow tubular segment 24. The hollow tubular segment 24 is provided in the form of a hollow cylindrical tube made of cellulose acetate. The hollow tubular segment 24 defines an internal cavity 26 that extends all the way from an upstream end 30 of the hollow tubular segment to a downstream end 32 of the hollow tubular segment 20. The internal cavity 26 is substantially empty, and so substantially unrestricted airflow is enabled along the internal cavity 26. The hollow tubular segment 24—and, as a consequence, the support element 22—does not substantially contribute to the overall RTD of the aerosol-generating article 10. In more detail, the RTD of the first hollow tubular segment 24 (which is essentially the RTD of the support element 22) is substantially 0 millimetres H₂O.

The hollow tubular segment 24 has a length of about 16 millimetres, an external diameter of about 7.25 millimetres, and an internal diameter of about 1.9 millimetres. Thus, a thickness of a peripheral wall of the first hollow tubular segment 26 is about 2.67 millimetres.

In the embodiment of FIG. 2, the downstream section 14 further comprises a mouthpiece element 42 at a location downstream of the support element 22. In more detail, the mouthpiece element 42 is positioned immediately downstream of the support element 22. As shown in the drawing of FIG. 2, an upstream end of the mouthpiece element 42 abuts the downstream end of the support element 22.

The mouthpiece element 42 is provided in the form of a cylindrical plug of low-density cellulose acetate.

The mouthpiece element 42 has a length of about 12 millimetres and an external diameter of about 7.25 millimetres. The RTD of the mouthpiece element 42 is about 12 millimetres H₂O.

The aerosol-generating element 12 comprises a sheet of homogenised tobacco material gathered to form a rod having an external diameter of about 7.25 millimetres and a length of about 12 millimetres.

The aerosol-generating article 10 further comprises an elongate susceptor 44 within the aerosol-generating substrate 12. In more detail, the susceptor 44 is arranged substantially longitudinally within the aerosol-generating substrate, such as to be approximately parallel to the longitudinal direction of the aerosol-generating element 12. As shown in the drawing of FIG. 2, the susceptor 44 is positioned in a radially central position within the rod and extends effectively along the longitudinal axis of the aerosol-generating element 12.

The susceptor 44 extends all the way from an upstream end to a downstream end of the aerosol-generating element 12. In effect, the susceptor 44 has substantially the same length as the aerosol-generating element.

In the embodiment of FIG. 2, the susceptor 44 is provided in the form of a metallic strip and has a length of about 12 millimetres, a thickness of about 60 micrometres, and a width of about 4 millimetres.

The upstream section 16 comprises an upstream element 46 located immediately upstream of the aerosol-generating element 12, the upstream element 46 being in longitudinal alignment with the aerosol-generating element 12. In the embodiment of FIG. 1, the downstream end of the upstream element 46 abuts the upstream end of the aerosol-generating element 12. This advantageously prevents the susceptor 44 from being dislodged. Further, this ensures that the consumer cannot accidentally contact the heated susceptor 44 after use.

The upstream element 46 is provided in the form of a cylindrical plug of cellulose acetate circumscribed by a stiff wrapper. The upstream element 46 has a length of about 5 millimetres. The RTD of the upstream element 46 is about 30 millimetres H₂O.

The susceptor 44 is shown in more detail in FIG. 3. The outer surface of the metallic strip is coated with a layer 48 of a coating composition, the layer 48 having a thickness of about 30 micrometres.

An example of a suitable coating composition is shown below in Table 1:

TABLE 1
Coating composition

| | Amount |
|---|---|
| Component | (% by weight) |
| Water | 20 |
| Glycerol | 73.5 |
| Nicotine | 1.5 |
| Gelling agent | 3 |
| Lactic acid | 1 |
| Divalent cations | 1 |

As shown in FIG. 3, both a top side 50 and a bottom side of 52 the strip of the susceptor 44 are coated with a respective layer 54, 56 comprising the coating composition. Further, FIG. 3 shows how in accordance with one of the manufacturing methods described above, the susceptor 44 may be provided with protective layers 58, 60 applied over the layers 54, 56 comprising the coating composition.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-14. (canceled)

15. An aerosol-generating article for producing an inhalable aerosol upon heating, the aerosol-generating article comprising:
an aerosol-generating element comprising aerosol-generating substrate, wherein the aerosol-generating substrate comprises a homogenised tobacco material comprising aerosol former; and
a susceptor arranged within the aerosol-generating element and configured to heat the homogenised tobacco material, the susceptor being coated with a coating composition comprising at least 20 percent by weight of an aerosol former, the coating composition further comprising about 0.5 percent by weight to about 10 percent by weight of isolated nicotine or a monoprotic nicotine salt derived from tobacco or both.

16. The aerosol-generating article according to claim 15, wherein the susceptor is surrounded by the homogenised tobacco material.

17. The aerosol-generating article according to claim 15, wherein the susceptor is an elongate susceptor and extends longitudinally within the aerosol-generating element.

18. The aerosol-generating article according to claim 15, wherein the homogenised tobacco material is provided as a gathered sheet of homogenised tobacco material.

19. The aerosol-generating article according to claim 15, wherein the coating composition further comprises at least one gelling agent that forms a solid medium, the aerosol former being dispersed in the solid medium, with the isolated nicotine or monoprotic nicotine salt or both dispersed in the aerosol former.

20. The aerosol-generating article according to claim 19, wherein the gelling agent comprises carboxymethyl cellulose (CMC) or hydroxypropyl methylcellulose (HPMC) or both and the aerosol former comprises glycerol.

21. The aerosol-generating article according to claim 15, wherein the aerosol former accounts for at least about 50 percent by weight of the coating composition.

22. The aerosol-generating article according to claim 15, wherein the coating composition forms a layer on an outer surface of the susceptor, the layer having a thickness of at least about 1 micrometre.

23. The aerosol-generating article according to claim 15, wherein a content of aerosol former in the coating composition amounts for at least about 0.25 percent of an overall content of the aerosol former in the aerosol-generating article.

24. The aerosol-generating article according to claim 15,
further comprising a downstream section at a location downstream of the aerosol-generating element,
wherein the downstream section comprises a support element located immediately downstream of the aerosol-generating element, the support element being in longitudinal alignment with the aerosol-generating element and comprising a hollow tubular segment.

25. The aerosol-generating article according to claim 24, further comprising a mouthpiece element at a location downstream of the support element.

26. The aerosol-generating article according to claim 15, further comprising an upstream section at a location upstream of the aerosol-generating element, the upstream section comprising an upstream element positioned immediately upstream of the aerosol-generating element and having a resistance to draw (RTD) of less than about 80 millimetres H₂O.

27. A method of manufacturing an aerosol-generating article for generating an inhalable aerosol upon heating, the method comprising:
providing an aerosol-generating substrate comprising a homogenised tobacco material comprising aerosol former;
providing a protected coated susceptor, wherein the protected coated susceptor comprises a susceptor element coated with a coating composition comprising aerosol former and about 0.5 percent by weight to about 10 percent by weight of isolated nicotine or a monoprotic nicotine salt derived from tobacco or both, and a protective layer applied over the coating composition;
removing the protective layer to expose the coating composition and provide an unprotected coated susceptor; and
combining the unprotected coated susceptor and the aerosol-generating substrate to form an aerosol-generating element, such that the unprotected coated susceptor is arranged within the aerosol-generating element and configured to heat the homogenised tobacco material.

28. A method of manufacturing an aerosol-generating article for generating an inhalable aerosol upon heating, the method comprising:
providing an aerosol-generating substrate comprising a homogenised tobacco material comprising aerosol former;
providing a susceptor element;
coating the susceptor element with a coating composition comprising aerosol former and about 0.5 percent by weight to about 10 percent by weight of isolated nicotine or a monoprotic nicotine salt derived from tobacco or both to provide a coated susceptor; and
combining the coated susceptor and the aerosol-generating substrate to form an aerosol-generating element, such that the coated susceptor is arranged within the aerosol-generating element and configured to heat the homogenised tobacco material.
